(19) United States
(12) Patent Application Publication
(10) Pub. No.: US 2002/0021342 A1
(43) Pub. Date: Feb. 21, 2002

(54) Print medium and printing apparatus

(76) Inventors: Kenji Kawazoe, Kanagawa (JP); Hiroshi Tajika, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/905,099

(22) Filed: Jul. 16, 2001

(30) Foreign Application Priority Data
Jul. 17, 2000 (JP) 2000-216703

(51) Int. Cl. B41J 2/01

(52) U.S. Cl. 347/104

(57) ABSTRACT

A print medium to be applied to a printing apparatus has print areas on which to print desired images and a discard area or separably provided in at least one of the front and rear end portions thereof. The width of the discard area provided in the front end portion of the print medium is set wider than a distance from the front end of the print medium accommodating portion to the feeding means and a distance from the discharge means to the most downstream position printed by the printing means. The width of the discard area provided in the rear end portion of the print medium is set wider than a distance from the most upstream position printed by the printing means to the transport means.

This application is based on Patent Application No. 2000-216703 filed Jul. 17, 2000 in Japan, the content of which is incorporated hereinto by reference.

### BACKGROUND OF THE INVENTION

1. Field of the Invention

The present invention relates to a printing apparatus for printing information entered, such as a personal computer, a word processor, an electronic typewriter and a facsimile, and also to a print medium on which the printing apparatus can print images. More particularly, the invention relates to a print medium which has a plurality of print areas that can be separated from one another without using a tool such as a cutter or scissors and to a printing apparatus for printing on the medium.

2. Description of the Related Art

A printing apparatus is known to be able to print on a variety of sizes of print mediums, such as A4, A5 (according to Japanese Industrial standards) and postcard size. This type of printing apparatus generally has a poor transport performance for small print mediums of postcard size or smaller and thus has difficulty printing accurately at a predetermined position on such small print mediums. To deal with this problem, a method has been practiced which involves printing a plurality of images parallelly on a large print medium and cutting the images apart using a tool such as a cutter. Other methods have been proposed in Japanese Patent Application Laid-Open No. 10-230684 which involve forming a plurality of print areas on a print medium each enclosed by perforations or using detachable labels attached on a base sheet as print areas in order to allow small-size print areas to be separated easily.

FIG. 18 shows the configuration of a conventional perforated print medium. One sheet of the print medium shown here is so arranged as to allow four individual images to be printed thereon. That is, the print medium 1 has three vertical lines of perforations 2a′, 2b′, 2c′ and three horizontal lines of perforations 3a′, 3b′, 3c′. In areas enclosed by these vertical and horizontal lines of perforations are formed four independent print areas (4a′, 4b′, 4c′, 4d′). The images to be printed on the print medium are edited automatically or manually using an ink jet printing apparatus and an edit/layout application program not shown.

When a print medium is inserted into the printing apparatus and the print operation is started, the same or different images are printed at separate appropriate positions on the medium. After printing, the user separates the printed images from each other along the lines of perforations 2, 3. Printing the images on beyond the lines of perforations is not desirable as this will print the images 4 one upon the other and disturb them (overlap printing). The print medium transport performance of the ink jet printing apparatus and variations in the size of the print medium normally result in print position deviations of the order of a few millimeters. Hence, it is conventional practice to print an image a few millimeters more smallish inside the lines of perforations.

As a result, a strip of white blank frame a few millimeters wide remains along the perforated lines around each separated image. That is, the printing of an entire surface of each print area (hereinafter referred to as a full bleed printing) as with a silver halide photography cannot be obtained.

To deal with this situation it has been proposed to fully print an image up to the perforated line of each print area to realize the full bleed printing. This method enables the full bleed printing by providing a discard area outside the individual image separation lines (Japanese Patent Application Laid-Open Nos. 11-277879 and 10-1666748).

FIG. 19 shows a conventional perforated print medium that enables the full bleed printing. Here, a single print medium allows for the full bleed printing of four individual images. The print medium 1′ is formed with four vertical perforated lines 2a″, 2b″, 2c″, 2d″ and four horizontal perforated lines 3a″, 3b″, 3c″, 3c″. These vertical and horizontal perforated lines form four independent print areas 4′ (4a″, 4b″, 4c″, 4d″). Hence, each image always has a discard area along its peripheral portion, with the print medium formed with three vertical discard areas 5a, 5b, 5c and three horizontal discard areas 6a, 6b, 6c.

The printing of an image in each print area is performed up to α″ mm outside the horizontal line Lx″ and vertical line Ly″ of the print area. Hence, the image separated along the perforated lines is a full bleed printed image.

It is preferred, however, that the width of the vertical discard area 5b (β″ mm) enclosed by the perforated lines 2b″, 2c″ be set to more than about two times the width of the excess printed strip mentioned above (α″). If the width of the discard area is less than that, when the excess printed strips of the laterally or vertically adjacent images overlap, the print medium will not be able to absorb ink, causing the ink to flow, disturbing the images or contaminating the hands of the user. In practical use, therefore, the discard area needs to be at least about 5 mm in width, considering that the printed area is separated along the perforated lines by the user. When in particular a long strip of the discard area is to be separated, only a few millimeters of width may result in the strip being broken in the middle of the separation process and the cut edge becoming rough, thus spoiling the appearance of the separated print area. Therefore, a sufficient discard area must be provided.

In recent years, another method is also available which achieves the full bleed printing by feeding paper from a roll paper holder, continuously printing images on a plurality of print areas and then separating the individual print areas.

In the ink jet printing apparatus of recent years with ever improving image quality, there are growing demands for higher performances, as good as or better than the silver halide photography, not only in terms of image quality but also other respects including a wider variety of forms of output. Against this background, there exists a need for the realization of the full bleed printing described above.

Because of a current practice in which an image shot by a digital camera is printed by a personal printer, there is a need for a printer capability to print out an image in a size similar to that of silver halide pictures (DCS; 3:4 ratio, L size, 4″×6″ size, 2L size, 8″×10″ size, etc.).

Photographic images generally have a higher print density than those of characters and images and thus require a greater amount of ink to be applied to the print medium. In an ink jet printing apparatus that employs a variable tone printing method using multiple kinds of ink (e.g., six kinds) including dark inks and light inks, the tendency for an increased amount of applied ink becomes more significant, causing problems such as deformations of a print medium (curling and cockling).

An ordinary printing apparatus has a paper feeding means for containing a plurality of print mediums and separating and feeding one sheet at a time, a transport means for transporting the print medium fed from the feeding means, a printing means for printing images on the print medium, and a discharge means for discharging the printed medium out of the printing apparatus. Printing on the above-described perforated print medium by using this printing apparatus, however, produced a problem that the print medium failed to be fed or moved properly by the feeding means, the transport means and the discharge means due to the influences of the perforations.

Further in the ordinary printing apparatus, although the printing operation can be carried out accurately when the print medium is fed by both the transport means and the discharge means, a problem of poor feeding accuracy and therefore disturbed printed image arises when the print medium is transported by only the transport means or the discharge means.

Hence, when the print medium is perforated to form discard areas to perform the full bleed printing, the printed image is disturbed at the front and rear end portions of the print medium.

### SUMMARY OF THE INVENTION

It is an object of the present invention to provide a print medium with a separable print area which enables a printing apparatus to properly and reliably supply and transport the print medium and thereby produce a satisfactory image quality. Another object of the present invention is to provide a printing apparatus which can properly and reliably supply and transport the print medium with a separable print area and thereby produce a satisfactory image quality.

To achieve the above objective, the present invention has the following construction.

According to one aspect, the present invention provides a print medium to be supplied to a printing apparatus, wherein the printing apparatus has a feeding means for feeding the print medium accommodated in a predetermined accommodating portion to a transporting passage facing a predetermined printing means and transports the print medium fed by the feeding means along the transporting passage so that the printing means can print on the print medium, the print medium comprising: a print area on which to print a desired image; and a discard area provided separably in at least a front end portion of the print medium; wherein a width of the discard area provided in at least the front end portion is set larger than a distance from a front end of the accommodating portion to the feeding means.

According to another aspect, the present invention provides a print medium to be applied to a printing apparatus, wherein the printing apparatus has a transport means for transporting the print medium along a transporting passage facing a printing means and a discharge means arranged downstream of the transport means, and at least one of the transport means and the discharge means transports the print medium along the transporting passage so that the printing means can print on the print medium, the print medium comprising: a print area on which to print a desired image; and a discard area provided separably in at least a front end portion of the print medium; wherein a width of the discard area provided in the front end portion of print medium is set larger than a distance from a most downstream position printed by the printing means to the discharge means.

According to still another aspect, the present invention provides a print medium to be applied to a printing apparatus, wherein the printing apparatus has a transport means for transporting the print medium along a transporting passage facing a printing means and a discharge means arranged downstream of the transport means, and at least one of the transport means and the discharge means transports the print medium along the transporting passage so that the printing means can print on the print medium, the print medium comprising: a print area on which to print a desired image; and a discard area provided separably in at least a rear end portion of the print medium; wherein a width of the discard area is set larger than a distance from a most upstream position printed by the printing means to the transport means.

According to a further aspect, the present invention provides a print medium to be applied to a printing apparatus, wherein the printing apparatus has a feeding means for feeding the print medium accommodated in a predetermined accommodating portion to a transporting passage facing a predetermined printing means, a transport means for transporting the print medium along a transporting passage and a discharge means arranged downstream of the transport means, and wherein after the print medium has been fed to the transporting passage, at least one of the transport means and the discharge means transports the print medium along the transporting passage so that the printing means can print on the print medium, the print medium comprising: a print area on which to print a desired image; and a discard area separably provided in at least a front end portion and a rear end portion of the print medium; wherein a width of the discard area provided in the front end portion of the print medium is set larger than a distance from a front end of the accommodating portion to the feeding means or a distance from a most downstream position printed by the printing means to the discharge means, whichever is a greater distance; wherein a width of the discard area provided in the rear end portion of the print medium is set larger than a distance from a most upstream position printed by the printing means to the transport means.

According to a further aspect, the present invention provides a printing apparatus comprising: an accommodating portion for accommodating a print medium, the print medium having a print area on which to print an image and a separable discard area in at least one of a front end portion and a rear end portion hereof; and a feeding means for feeding the print medium accommodated in the accommodating portion to a transporting passage facing a predetermined printing means; wherein the print medium fed by the feeding means is transported along the transporting passage so that the printing means can print on the print medium; wherein the accommodating portion has a dimensional setting such that a distance from a front end of the accommodating portion to the feeding means is set smaller than a width of the discard area in the front end portion of the print medium.

According to a further aspect, the present invention provides a printing apparatus comprising: a transport means for transporting a print medium along a transporting passage facing a printing means, the print medium having a print area on which to print an image and a discard area separably provided in at least one of a front end portion and a rear end portion thereof; and a discharge means arranged downstream of the transport means; wherein at least one of the transport means and the discharge means transports the print medium along the transporting passage so that the printing means can print on the print medium; wherein a distance from a most downstream position printed by the printing means to the discharge means is set smaller than a width of the discard area provided in the front end portion of the print medium.

According to a further aspect, the present invention provides a printing apparatus comprising: a transport means for transporting a print medium along a transporting passage facing a printing means, the print medium having a print area on which to print an image and a discard area separably provided in at least one of a front end portion and a rear end portion thereof; and a discharge means arranged downstream of the transport means; wherein at least one of the transport means and the discharge means transports the print medium along the transporting passage so that the printing means can print on the print medium; wherein a distance from a most upstream position printed by the printing means to the transport means is set smaller than a width of the discard area provided in the rear end portion of the print medium.

According to a further aspect, the present invention provides a printing apparatus comprising: a feeding means for feeding a print medium to a transporting passage facing a predetermined printing means, the print medium having a print area on which to print an image and a discard area separably provided in at least one of a front end portion and a rear end portion thereof; a transport means for transporting the print medium along the transporting passage; and a discharge means arranged downstream of the transport means; wherein after the print medium accommodated in a predetermined accommodating portion has been fed to the transporting passage, at least one of the transport means and the discharge means transports the print medium along the transporting passage so that the printing means can print on the print medium; wherein the print medium has a print area on which to print a desired image and a discard area separably provided in at least a front end portion and a rear end portion thereof; wherein a distance from a most downstream position printed by the printing means to the discharge means or a distance from a most upstream position printed by the printing means to the transport means, whichever is a greater distance, is set smaller than a width of the discard area provided in the front end portion of the print medium, and a distance from a most upstream position printed by the printing means to the transport means is set smaller than a width of the discard area provided in the rear end portion of the print medium.

The print medium of this invention has a print area on which to print a desired image and a discard area separably provided in at least one of the front end portion and the rear end portion thereof. At the same time the width of the discard area is set larger than the distance from the front end of the accommodating portion to the feeding means. This arrangement enables the printing apparatus to feed the print medium precisely without an error, thereby producing a high quality image.

Further, because the width of the discard area provided in the front end portion of the print medium is set larger than the distance from the most downstream position printed by the printing means to the discharge means, the printing apparatus can transport the print medium precisely without any transport error, thus producing a high quality image.

Further, as to the discard areas separably provided before and after a plurality of print areas and each of the print areas on the print medium, the discard area in the front end portion of the print medium and the discard area in the rear end portion of the print medium are set equal in width, and the discard area in the left end portion of the print medium and the discard area in the right end portion of the print medium are set equal in width. This eliminates the need to check the left and right sides of the print medium when supplying the print mediums into the printing apparatus, facilitating the paper feeding operation.

Further, because the width of the excess printed strip spreading into the discard areas is optimized, it is possible to prevent an improper transport of print medium due to a reduced stiffness of the medium and to improve the ease with which to handle the printed medium.

Further, in the printing apparatus according to this invention, because the distance from the front end of the print medium accommodating portion to the feeding means is set smaller than the width of the discard area, the print medium can be fed precisely without an error.

Further, in the printing apparatus according to this invention, because the distance from the most downstream position printed by the printing means to the discharge means is set smaller than the width of the discard area in the front end portion of the print medium, the print medium can be transported precisely without an error.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a perspective view showing an external construction of an ink jet printer as one embodiment of the present invention;

FIG. 2 is a perspective view showing the printer of FIG. 1 with an enclosure member removed;

FIG. 3 is a side view of FIG. 2;

FIG. 4 is a front view showing a feed roller and an LF gear cover shown in FIG. 2;

FIG. 5 is a perspective view showing pinch rollers and others shown in FIG. 2;

FIG. 6 is a perspective view showing an assembled print head cartridge used in the printer of one embodiment of the present invention;

FIG. 7 is an exploded perspective view showing the print head cartridge of FIG. 6;

FIG. 8 is an exploded perspective view of the print head of FIG. 7 as seen from diagonally below;

FIG. 9 is a perspective view showing the front side of a carriage used in the embodiment of the invention;

FIG. 10 is a perspective view showing the back side of the carriage of FIG. 9;

FIG. 11 is a perspective view showing one side of an ejection performance recovery unit in the embodiment of the invention;

FIG. 12 is a perspective view showing the other side of the ejection performance recovery unit of FIG. 11;

FIG. 13 is a flow chart showing an example of operation of the printer as one embodiment of the present invention;

FIG. 14 is a schematic plan view showing a full bleed print medium according to the first embodiment of the invention;

FIG. 15 is a partly cutaway, schematic vertical side view showing a transport system of the printing apparatus according to the embodiment of the invention;

FIGS. 16A, 16B and 16C are schematic side views showing how the print medium is fed in the printing apparatus according to the invention;

FIG. 17 is a schematic plan view showing a print medium according to another embodiment of the invention;

FIG. 18 is a schematic plan view showing a conventional full bleed print medium; and

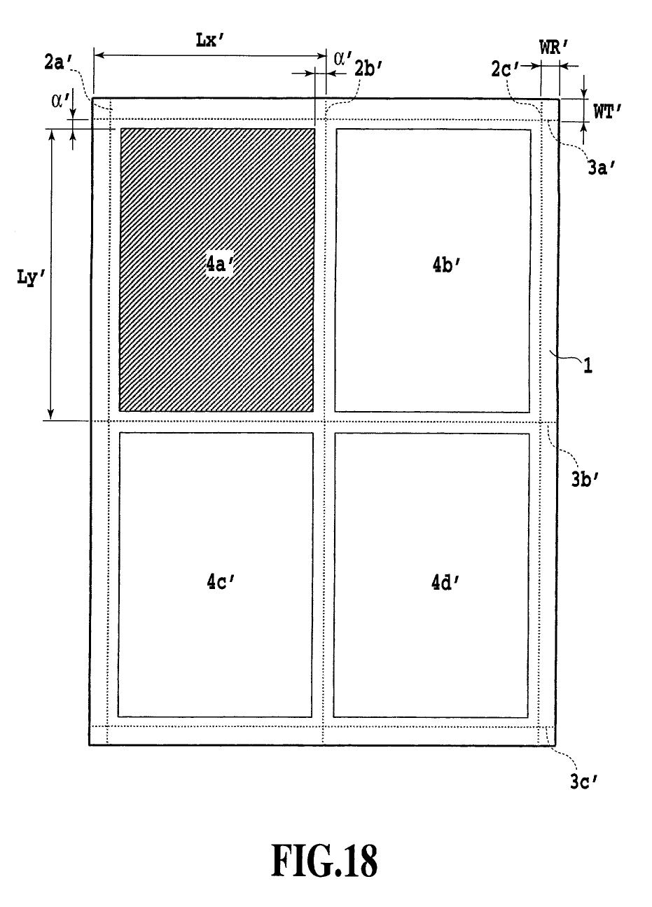

FIG. 19 is a schematic plan view showing a conventional full bleed print medium.

### DETAILED DESCRIPTION OF PREFERRED EMBODIMENTS

Embodiments of the printing apparatus according to the present invention will be described by referring to the accompanying drawings.

In this specification, a word “print” (or “record”) refers to not only forming significant information, such as characters and figures, but also forming images, designs or patterns on printing medium and processing media, whether the information is significant or insignificant or whether it is visible so as to be perceived by humans.

The word “print medium” or “print sheet” include not only paper used in common printing apparatus, but cloth, plastic films, metal plates, glass, ceramics, wood, leather or any other material that can receive ink. This word will be also referred to “paper”.

Further, the word “ink” (or “liquid”) should be interpreted in its wide sense as with the word “print” and refers to liquid that is applied to the printing medium to form images, designs or patterns, process the printing medium or process ink (for example, coagulate or make insoluble a colorant in the ink applied to the printing medium).

In the following description we take up as an example a printing apparatus using an ink jet printing system.

I. Fundamental Construction

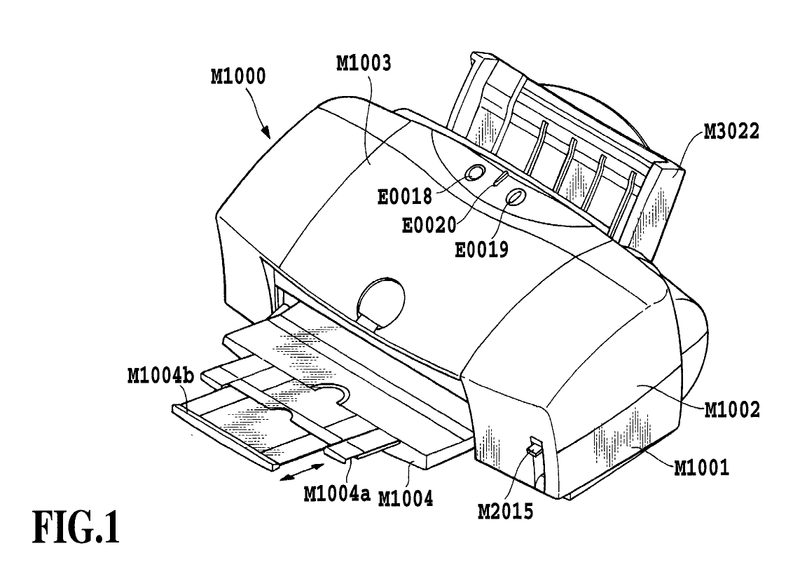

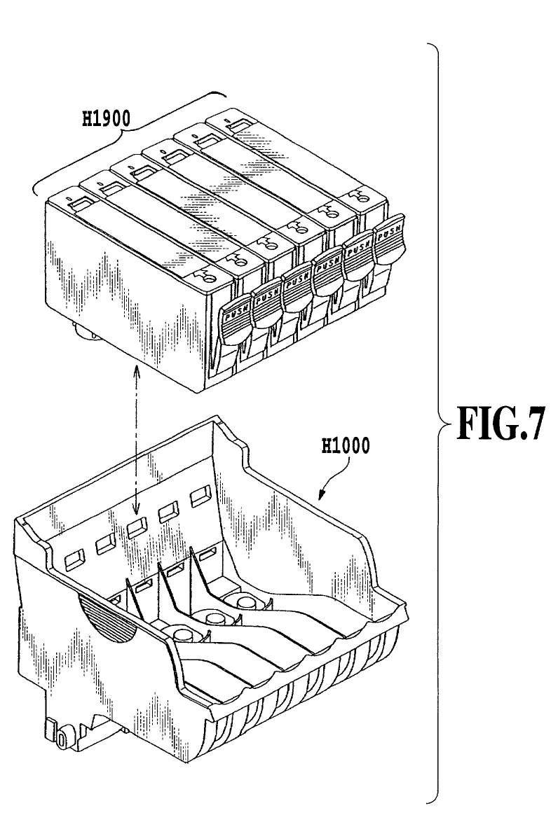

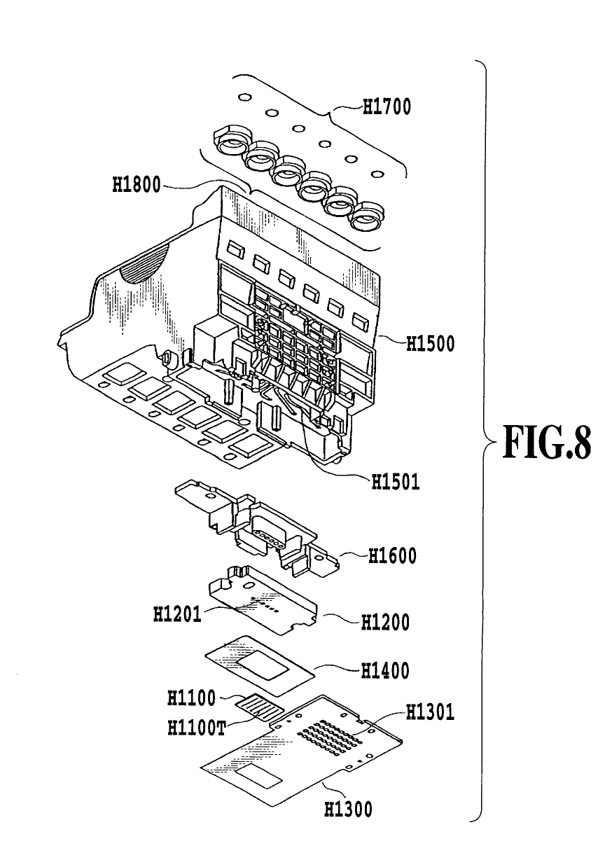

By referring to FIGS. 1 to 13 a fundamental construction of a printer will be described.

I.1 Apparatus Body

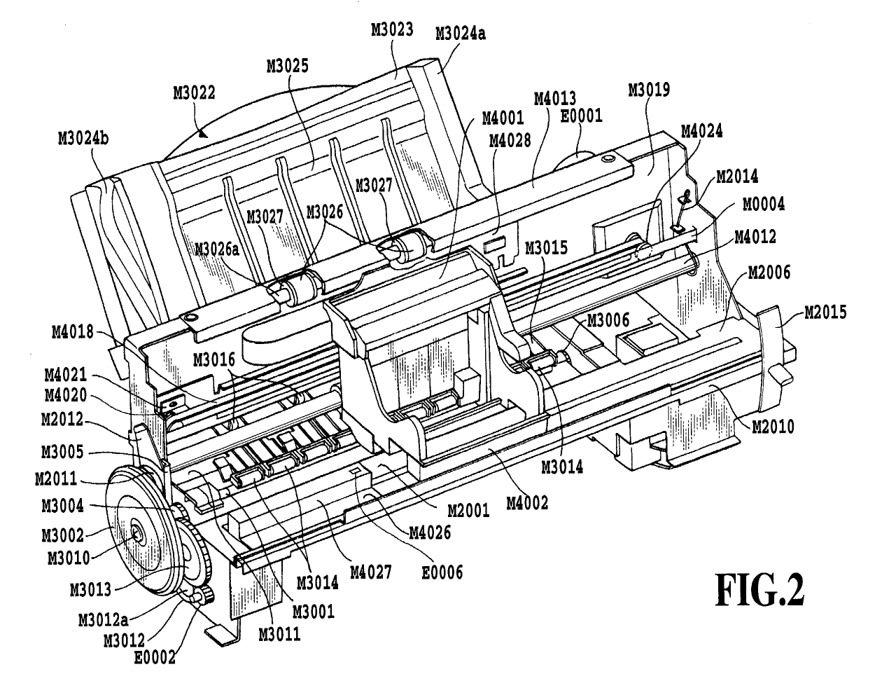

FIGS. 1 and 2 show an outline construction of a printer using an ink jet printing system. In FIG. 1, a housing of a printer body M1000 of this embodiment has an enclosure member, including a lower case M1001, an upper case M1002, an access cover M1003 and a discharge tray M1004, and a chassis M3019 (see FIG. 2) accommodated in the enclosure member.

The chassis M3019 is made of a plurality of plate-like metal members with a predetermined rigidity to form a skeleton of the printing apparatus and holds various printing operation mechanisms described later.

The lower case M1001 forms roughly a lower half of the housing of the printer body M1000 and the upper case M1002 forms roughly an upper half of the printer body M1000. These upper and lower cases, when combined, form a hollow structure having an accommodation space therein to accommodate various mechanisms described later. The printer body M1000 has an opening in its top portion and front portion.

The discharge tray M1004 has one end portion thereof rotatably supported on the lower case M1001. The discharge tray M1004, when rotated, opens or closes an opening formed in the front portion of the lower case M1001. When the print operation is to be performed, the discharge tray M1004 is rotated forwardly to open the opening so that printed sheets can be discharged and successively stacked. The discharge tray M1004 accommodates two auxiliary trays M1004a, M1004b. These auxiliary trays can be drawn out forwardly as required to expand or reduce the paper support area in three steps.

The access cover M1003 has one end portion thereof rotatably supported on the upper case M1002 and opens or closes an opening formed in the upper surface of the upper case M1002. By opening the access cover M1003, a print head cartridge H1000 or an ink tank H1900 installed in the body can be replaced. When the access cover M1003 is opened or closed, a projection formed at the back of the access cover, not shown here, pivots a cover open/close lever. Detecting the pivotal position of the lever as by a micro-switch and so on can determine whether the access cover is open or closed.

At the upper rear surface of the upper case M1002 a power key, a resume key and an LED are provided. When the power key is pressed, the LED lights up indicating to an operator that the apparatus is ready to print. The LED has a variety of display functions, such as alerting the operator to printer troubles as by changing its blinking intervals and color. Further, a buzzer may be sounded. When the trouble is eliminated, the resume key is pressed to resume the printing.

I.2 Printing Operation Mechanism

Next, a printing operation mechanism installed and held in the printer body M1000 according to this embodiment will be explained.

The printing operation mechanism in this embodiment comprises: an automatic sheet feed unit M3022 to automatically feed a print sheet into the printer body; a sheet transport unit M3029 to guide the print sheets, fed one at a time from the automatic sheet feed unit, to a predetermined print position and to guide the print sheet from the print position to a discharge unit M3030; a print unit M4000 to perform a desired printing on the print sheet carried to the print position; and an ejection performance recovery unit M5000 to recover the ink ejection performance of the print unit M4000.

Next, the construction of each mechanism will be explained.

I.2.1 Automatic Sheet Feed Unit

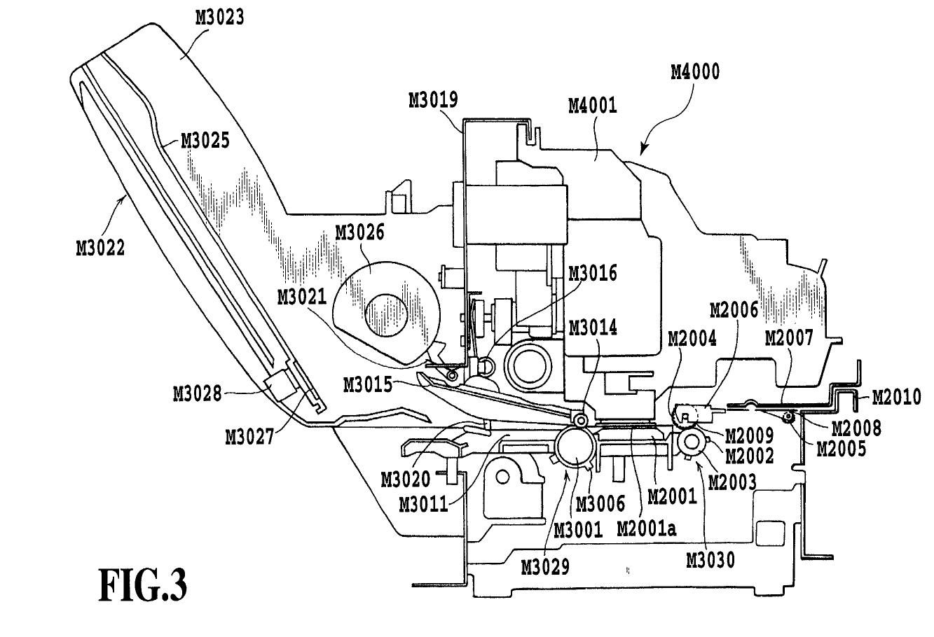

By referring to FIGS. 2 and 3 the automatic sheet feed unit M3022 will be described.

The automatic sheet feed unit M3022 in this embodiment horizontally feeds one of print sheets stacked at an angle of about 30-60 degrees to the horizontal plane, so that the sheet is discharged out of a sheet feed port not shown into the printer body while being kept in an almost horizontal attitude.

The automatic sheet feed unit M3022 includes feed rollers M3026, sheet guides M3024a, M3024b, a pressure plate M3025, an ASF base M3023, sheet separators M3027, and separation claws not shown. The ASF base M3023 forms a housing of the automatic sheet feed unit M3022 and is provided at the back of the printer body. On the front side of the ASF the pressure plate M3025 supporting the print sheets is mounted at an angle of about 30-60 degrees to the horizontal plane and a pair of sheet guides M3024a, M3024b that guide the ends of the print sheets project forwardly. One of the sheet guides M3024b is movable in the sheet width direction to conform to the horizontal size (width) of the sheets.

Rotatably supported on the left and right sides of the ASF base M3023 is a drive shaft M3026a that is connected through a gear not shown to a PG motor and which has rigidly secured thereto a plurality of feed rollers M3026 semicircular in cross section.

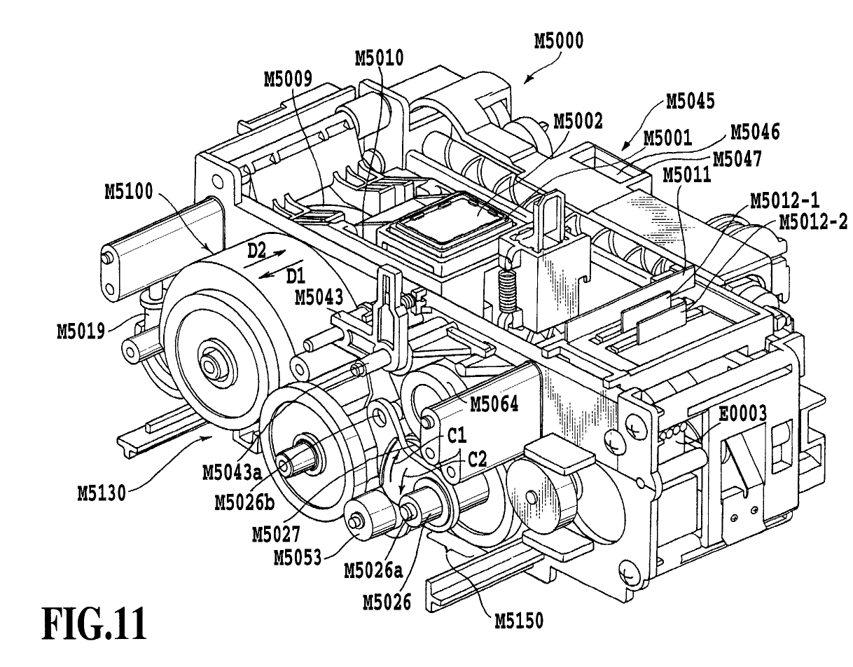

The print sheets stacked on the pressure plate M3025 are fed by the feed rollers M3026 that are driven by the PG motor E0003 (FIG. 11). The stacked sheets are separated one by one from the top of the stack by the sheet separators M3027 and the separation claws and forwarded to the paper transport unit M3029. The lower end of the pressure plate M3025 is resiliently supported by a pressure plate spring M3028 interposed between the pressure plate M3025 and the ASF base M3023, so that the contact force between the feed rollers and the sheet can be kept constant regardless of the number of sheets stacked.

In a transport path from the automatic sheet feed unit M3022 to the paper transport unit M3029, a PE lever M3020 urged clockwise in FIG. 3 by a PE lever spring M3021 is pivotally mounted on a chassis M3019 which is secured to the printer body M1000 and formed of a metal plate member with a predetermined rigidity. When the print sheet separated and fed from the automatic sheet feed unit M3022 moves along the path and its front end abuts against one end of the PE lever and pivots it, a PE sensor not shown senses the rotation of the PE lever M3020, detecting that the print sheet has entered into the transport path.

After the entrance into the transport path of the print sheet has been detected, the print sheet is transported a predetermined distance downstream by the feed rollers M3026. That is, the print sheet is fed until its front end contacts a nip portion formed by an LF roller M3001, which is at rest and provided in the paper transport unit described later, and pinch rollers M3014 and the print sheet deflects about 3 mm in loop, at which time the sheet is stopped.

I.2.2 Paper Transport Unit

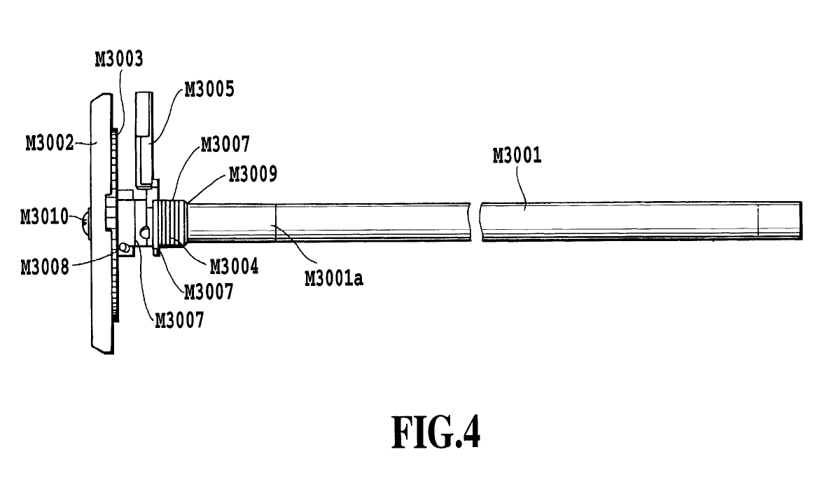

The paper transport unit M3029 has an LF roller M3001, pinch rollers M3014 and a platen M2001. The LF roller M3001 is secured to a drive shaft rotatably supported on the chassis M3019 and, as shown in FIG. 4, has attached to one end thereof an LF gear cover M3002 that protects both an LF gear M3003 secured to the drive shaft M3001a and a small gear M3012a (see FIG. 2) of an LF intermediate gear M3012 in mesh with the LF gear M3003. The LF intermediate gear M3012 is interlocked with a drive gear of a drive shaft of an LF motor E0002 described later and is driven by the driving force of the motor.

The pinch rollers M3014 are rotatably mounted at the front end of pinch roller holders M3015 which is pivotally supported on the chassis M3019. The pinch rollers M3014 are pressed against the LF roller M3001 by spiral spring-like pinch roller springs M3016 that bias the pinch roller holders M3015. As a result, the pinch rollers M3014 rotate following the rotation of the LF roller M3001 to feed forwardly the print sheet, which was at rest in a looped state as described above, by gripping it between the pinch rollers M3014 and the LF roller M3001.

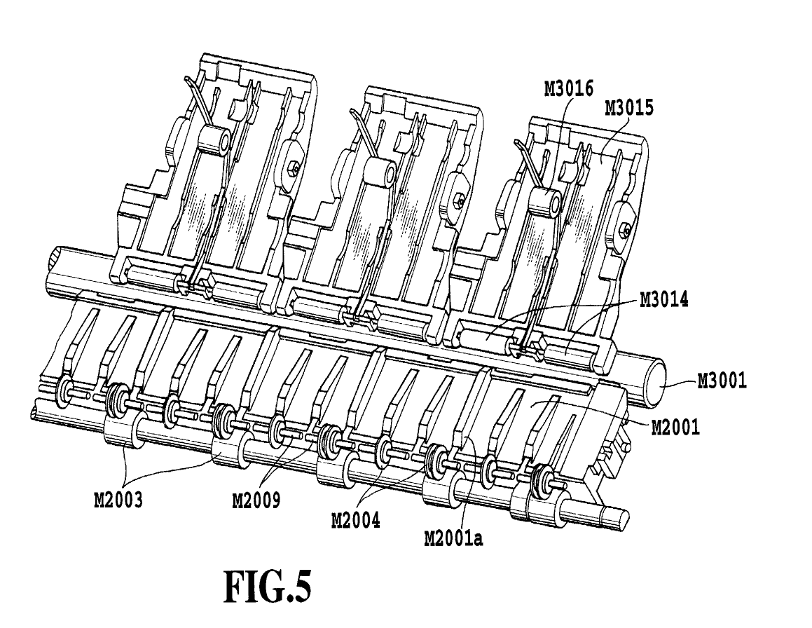

The rotation center of the pinch rollers M3014 is offset about 2 mm downstream of the rotation center of the LF roller M3001 in the direction of transport. Hence, the print sheet fed by the LF roller M3001 and the pinch rollers M3014 advances toward lower right in FIG. 3 along a print sheet support surface M2001a (FIG. 5).

A predetermined time after the feeding operation by the feed rollers M3026 of the automatic sheet feed unit M3022 has stopped, the paper transport unit constructed as described above starts the LF motor E0002. The driving force of the LF motor E0002 is transmitted via the LF intermediate gear M3012 and the LF gear M3003 to the LF roller M3001. As the LF roller M3001 rotates, the print sheet whose front end is in contact with the nip portion between the LF roller M3001 and the pinch rollers M3014 is carried to the print start position on the platen M2001.

At this time, the feed rollers M3026 resume rotating simultaneously with the LF roller M3001, so that the print sheet is transported downstream by the cooperation of the feed rollers M3026 and the LF roller M3001 for a predetermined period of time.

A print head cartridge H1000 described later moves, mounted on a carriage M4001, along a carriage shaft M4012 secured at its ends to the chassis M3019, the carriage M4001 being adapted to reciprocate in a direction (scan direction) perpendicular to the direction in which the print sheet is fed. As it travels in the scan direction, the print head cartridge H1000 ejects ink, according to an image information, onto the print sheet held at the print start position to form an image.

After the image has been printed, the LF roller M3001 is rotated to feed the print sheet a predetermined distance at a time, which may correspond to one line height of, for example, 5.42 mm, followed by the carriage M4001 performing the main scan along the carriage shaft M4012. This process is repeated to complete an entire image on the print sheet placed on the platen M2001.

The carriage shaft M4012 has its one end mounted on an adjust plate (not shown) through an adjust lever 2015 and the other end mounted on another adjust plate M2012 through a carriage shaft cam M2011. The carriage shaft M4012 is biased by a carriage shaft spring M2014. The adjust plate M2012 and the other adjust plate not shown are secured to the chassis M3019 so that the distance between the ejecting face of the print head cartridge H1000 and the print sheet support surface M2001a of the platen M2001 can be adjusted to be an appropriate value.

Further, the adjust lever 2015 can be selectively set at one of two stop positions, an upper end position shown in FIG. 1 and a lower end position not shown. When the adjust lever 2015 is moved to the lower end position, the carriage M4001 is retracted about 0.6 mm from the platen M2001. Hence, if the print sheet is thick, as when an envelope is printed, the adjust lever 2015 is moved to the lower end position before the sheet feeding operation by the automatic sheet feed unit M3022 is started.

When the adjust lever 2015 is located at the lower end position, this state is detected by the GAP sensor. Therefore, when the print sheet begins to be fed by the automatic sheet feed unit M3022, it is checked whether the position setting of the adjust lever 2015 is appropriate or not. When an inappropriate state is detected, a warning is issued by displaying a message or activating a buzzer to prevent the printing operation from being executed in an inappropriate condition.

I.3 Discharge Unit

Next, the discharge unit M3030 will be described by referring to FIGS. 2 and 3.

As shown in FIG. 3, the discharge unit M3030 has a discharge roller 2003; a discharge gear M3013 mounted on the discharge roller 2003 to transmit the driving force of the LF motor E0002 through the LF intermediate gear M3012 to the discharge roller 2003; a first spur M2004 rotated by the rotation of the discharge roller 2003 to grip the print sheet between it and the discharge roller 2003 to feed the sheet, and a discharge tray M1004 to aid in the discharge of the print sheet. The first spur M2004 is pressed against the discharge roller 2003 by a biasing force of a spur spring M2009 attached to a first spur holder M2006 mounted on a spur stay M2007.

The print sheet carried to the discharge unit M3030 is subjected to the transport force from the discharge roller 2003 and the first spur M2004. The rotation center of the first spur M2004 is offset about 2 mm upstream, in the transport direction, of the rotation center of the discharge roller 2003. Hence, the print sheet moved by the discharge roller 2003 and the first spur M2004 comes into light contact with the print sheet support surface M2001a of the platen M2001 with no gap between them and is therefore transported properly and smoothly.

The speed of the print sheet carried by the discharge roller 2003 and the first spur M2004 is almost equal to the speed of the sheet fed by the LF roller M3001 and the pinch roller M3014. To effectively prevent the print sheet from becoming slack, the speed at which the sheet is moved by the discharge roller 2003 and the first spur M2004 is set slightly higher.

Further, a second spur M2005 accommodated in a second spur holder M2008 is held on a part of the spur stay M2007 downstream of the first spur M2004 to prevent the print sheet from coming into a frictional, sliding contact with the spur stay M2007.

When the printing of an image on the print sheet is finished and the rear end of the print sheet comes off from between the LF roller M3001 and the pinch roller M3014, the print sheet is moved only by the discharge roller 2003 and the first spur M2004 until it is completely discharged.

I.4 Print Unit

Here, the print unit M4000 will be described. The print unit M4000 comprises a carriage M4001 movably supported on a carriage shaft M4021 and a print head cartridge H1000 removably mounted on the carriage M4001.

I.4.1 Print Head Cartridge

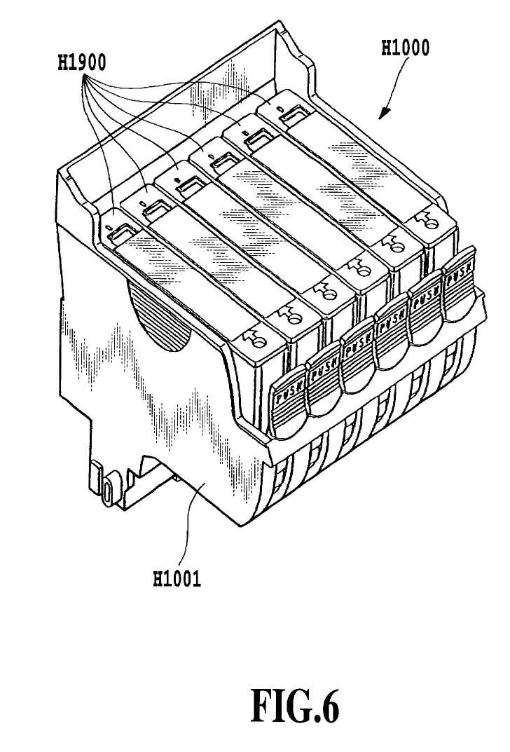

First, the print head cartridge used in the print unit will be described with reference to FIGS. 6 to 8.

The print head cartridge H1000 in this embodiment, as shown in FIG. 3, has an ink tank H1900 containing inks and a print head H1001 for ejecting ink supplied from the ink tank H1900 out through nozzles according to print information. The print head H1001 is of a so-called cartridge type in which it is removably mounted to the carriage M4001 described later.

The ink tank for this print head cartridge H1000 consists of separate ink tanks H1900 of, for example, black, light cyan, light magenta, cyan, magenta and yellow to enable color printing with as high an image quality as photograph. As shown in FIG. 4, these individual ink tanks are removably mounted to the print head H1001.

Then, the print head H1001, as shown in the perspective view of FIG. 5, comprises a print element substrate H1100, a first plate H1200, an electric wiring board H1300, a second plate H1400, a tank holder H1500, a flow passage forming member H1600, a filter H1700 and a seal rubber H1800.

The print element silicon substrate H1100 has formed in one of its surfaces, by the film deposition technology, a plurality of print elements to produce energy for ejecting ink and electric wires, such as aluminum, for supplying electricity to individual print elements. A plurality of ink passages and a plurality of nozzles H1100T, both corresponding to the print elements, are also formed by the photolithography technology. In the back of the print element substrate H1100, there are formed ink supply ports for supplying ink to the plurality of ink passages. The print element substrate H1100 is securely bonded to the first plate H1200 which is formed with ink supply ports H1201 for supplying ink to the print element substrate H1100. The first plate H1200 is securely bonded with the second plate H1400 having an opening. The second plate H1400 holds the electric wiring board H1300 to electrically connect the electric wiring board H1300 with the print element substrate H1100. The electric wiring board H1300 is to apply electric signals for ejecting ink to the print element substrate H1100, and has electric wires associated with the print element substrate H1100 and external signal input terminals H1301 situated at electric wires' ends for receiving electric signals from the printer body. The external signal input terminals H1301 are positioned and fixed at the back of a tank holder H1500 described later.

The tank holder H1500 that removably holds the ink tank H1900 is securely attached, as by ultrasonic fusing, with the flow passage forming member H1600 to form an ink passage H1501 from the ink tank H1900 to the first plate H1200. At the ink tank side end of the ink passage H1501 that engages with the ink tank H1900, a filter H1700 is provided to prevent external dust from entering. A seal rubber H1800 is provided at a portion where the filter H1700 engages the ink tank H1900, to prevent evaporation of the ink from the engagement portion.

As described above, the tank holder unit, which includes the tank holder H1500, the flow passage forming member H1600, the filter H1700 and the seal rubber H1800, and the print element unit, which includes the print element substrate H1100, the first plate H1200, the electric wiring board H1300 and the second plate H1400, are combined as by adhesives to form the print head H1001.

I.4.2 Carriage

Next, by referring to FIGS. 2, 9 and 10, the carriage M4001 carrying the print head cartridge H1000 will be explained.

As shown in FIG. 2, the carriage M4001 has a carriage cover M4002 for guiding the print head H1001 to a predetermined mounting position on the carriage M4001, and a head set lever M4007 that engages and presses against the tank holder H1500 of the print head H1001 to set the print head H1001 at a predetermined mounting position.

That is, the head set lever M4007 is provided at the upper part of the carriage M4001 so as to be pivotable about a head set lever shaft M4008. There is a spring-loaded head set plate (not shown) at an engagement portion where the carriage M4001 engages the print head H1001. With the spring force, the head set lever M4007 presses against the print head H1001 to mount it on the carriage M4001.

At another engagement portion of the carriage M4001 with the print head H1001, there is provided a contact flexible printed cable (simply referred to as a contact FPC hereinafter) E0011 whose contact unit E0011a electrically contacts a contact portion (external signal input terminals) H1301 provided in the print head H1001 to transfer various information for printing and supply electricity to the print head H1001.

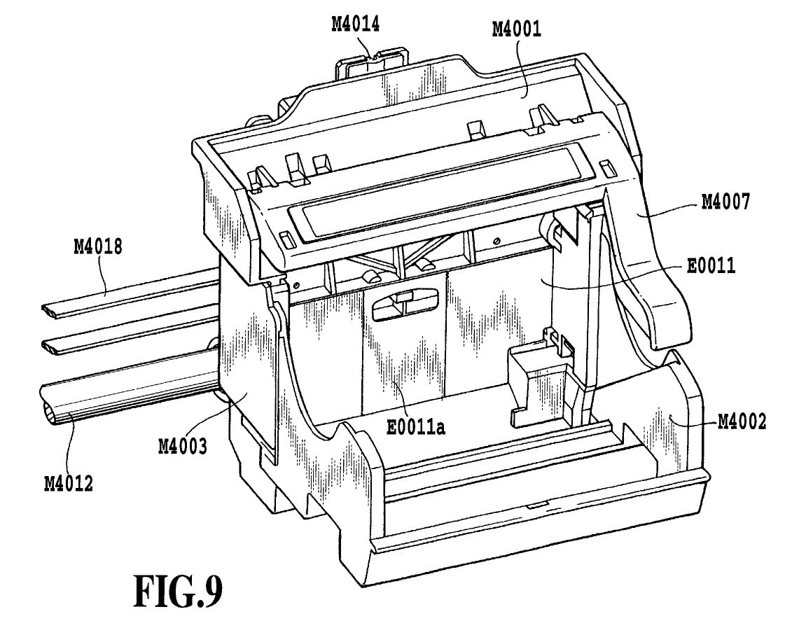

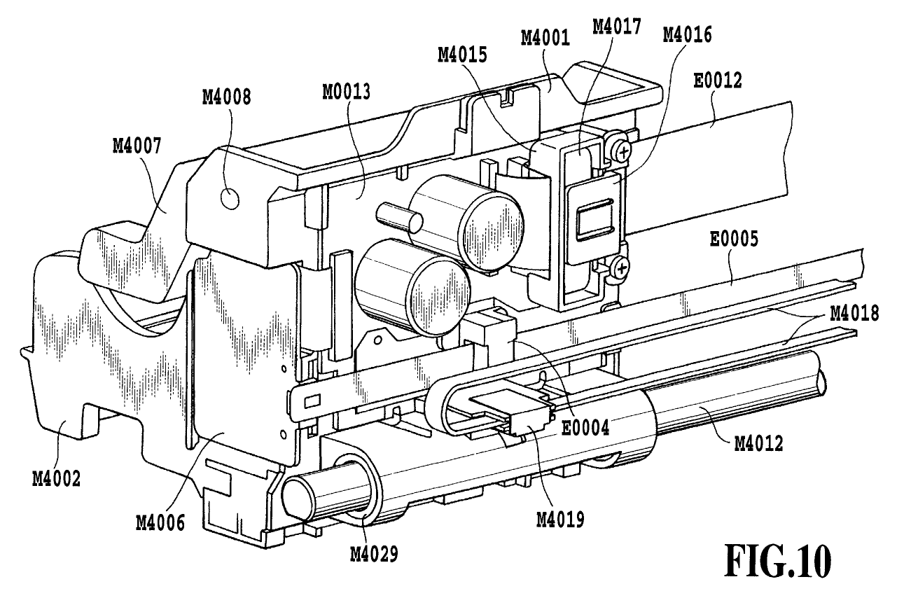

An elastic member such as rubber not shown is provided between a contact unit E0011a of a contact FPC E0011 and the carriage M4001. The elastic force of the elastic member and the pressing force of the head set lever spring combine to ensure a reliable contact between the contact unit E0011a and the carriage M4001. The contact FPC E0011 is drawn to the sides of the carriage M4001 and, as shown in FIGS. 9 and 10, has its end portions securely held to the sides of the carriage M4001 by a pair of FPC retainers M4003, M4006. The contact FPC E0011 is connected to a carriage printed circuit board E0013 mounted on the back of the carriage M4001 (see FIG. 10).

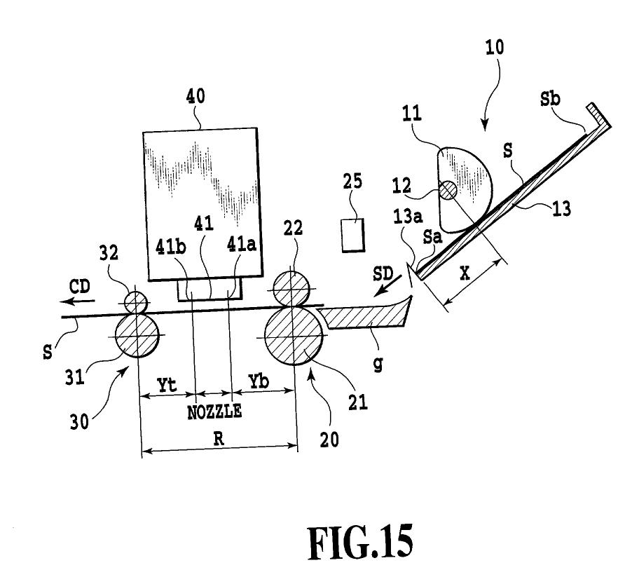

As shown in FIG. 10, the carriage printed circuit board E0013 is electrically connected through a carriage flexible flat cable (carriage FFC) to a main printed circuit board mounted on the chassis M3019 (see FIG. 15), which will be described later. Further, as shown in FIG. 10, at a joint portion between one end of the carriage FFC and the carriage printed circuit board a pair of retainer members, flexible flat cable retainers (FCC retainers) M4015, M4016, are provided to fixedly secure the carriage FFC to the carriage printed circuit board. Also installed at the joint portion is a ferrite core M4017 that shields electromagnetic radiations emitted from the carriage FFC and others.

The other end of the carriage FFC is fixed to the chassis M3019 (FIG. 2) by an FFC retainer M4028 (FIG. 2) and then drawn out to the rear side of the chassis M3019 through a hole not shown in the chassis M3019 and connected to the main printed circuit board.

As shown in FIG. 10, the carriage printed circuit board has an encoder sensor, which detects information from an encoder scale E0005 extending parallel to the carriage shaft M4012 between the both sides of the chassis M3019 to detect the position and scan speed of the carriage M4001. In this embodiment, the encoder sensor E0004 is of an optical transmission type. The encoder scale E0005 is a resin film, such as polyester film, which is printed, by the photographic plate making technique, alternately at a predetermined pitch with light shielding portions for shielding detection light emitted from the encoder sensor and light transmitting portions for transmitting the detection light.

Therefore, the position of the carriage M4001 moving along the carriage shaft M4012 can be detected at any time by first putting the carriage M4001 against one side plate of the chassis M3019 provided at an end of the scanning track of the carriage M4001, taking this position as a reference position, and counting the number of patterns formed on the encoder scale E0005 by the encoder sensor E0004 as the carriage M4001 performs scanning.

The carriage M4001 is guided for scan operation along the carriage shaft M4012 and the carriage rail M4013 extending between the both sides of the chassis M3019. At bearing portions for the carriage shaft M4012, the carriage M4001 has integrally formed therewith as by an insert molding a pair of carriage shaft bearings M4029 made of a sintered metal impregnated with lubricant such as oil. Further, at a portion engaging with the carriage rail M4013, the carriage M4001 has a carriage slider (CR slider) M4014 made of resin with excellent sliding performance and wear resistance. Along with the carriage shaft bearings M4029, the CR slider M4014 enables a smooth scanning motion of the carriage M4001.

The carriage M4001 is secured to a carriage belt M4018 that extends almost parallel to the carriage shaft between an idler pulley M4020 (FIG. 2) and a carriage motor pulley M4024 (FIG. 2). The carriage motor drives the carriage motor pulley M4024 to move the carriage belt M4018 in the forward or backward direction and thereby scan the carriage M4001 along the carriage shaft M4012. The carriage motor pulley M4024 is held at a fixed position by the chassis, whereas the idler pulley M4020 together with a pulley holder M4021 is held movable relative to the chassis M3019. Because the idler pulley M4020 is urged away from the carriage motor pulley M4024 by a spring, the carriage belt M4018 wound around the both pulleys M4020 and M4024 is given an appropriate tension at all times and thus kept in good state with no slack.

At the connecting portion between the carriage belt M4018 and the carriage M4001 is provided a carriage belt holder M4019 that ensures a secure holding of the carriage M4001 to the belt.

On the spur stay M2007 in the scanning track of the carriage M4001 an ink empty sensor E0006 (FIG. 2) is exposed facing an ink tank H1900 to measure the remaining amount of ink contained in the ink tank H1900 of the print head cartridge H1000 mounted on the carriage M4001. The ink empty sensor E0006 is held by an ink empty sensor holder M4026 and accommodated in an ink empty sensor cover M4027 having a metal plate to shield noise from outside, thus preventing erroneous operations of the sensor.

I.5 Ejection Performance Recovery Unit

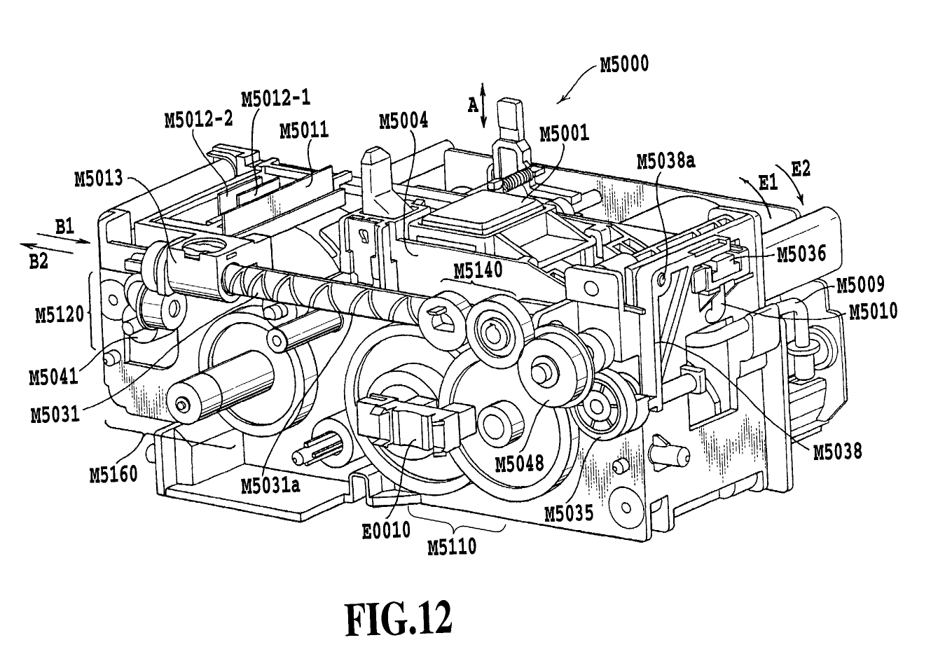

Next, by referring to FIGS. 11 and 12, an ejection performance recovery unit that recovers the ejection performance of the print head cartridge H1000 will be described.

The ejection performance recovery unit 5000 in this embodiment can be mounted to and dismounted from the printer body M1000. The ejection performance recovery unit M5000 has a cleaning means to remove foreign matters adhering to a print element substrate H1100 of the print head H1001 and a recovery means to reinstate the normal condition of the ink path from the ink tank H1900 to the print element substrate H1100 of the print head H1001 (flow path from the portions H1501 to H1400 via H1600).

In FIGS. 11 and 12, denoted E0003 is a PG motor which drives a cap M5001 to be described later, a pump M5100, wiper blades M5011, M5012-1, M5012-2 and the automatic sheet feed unit M3022. The driving force is extracted from both sides of the motor shaft of the PG motor E0003. The driving force extracted from one side is transmitted to the pump M5100 or the automatic sheet feed unit M3022 through a drive path switching means described later. The driving force extracted from the other side is transmitted to the cap M5001 and the wiper blades M5011, M5012-1, M5012-2 through a one-way clutch M5041 that engages when the PG motor E0003 rotates only in a particular direction (this rotation direction is referred to as a forward direction and the opposite direction as a reverse direction). Hence, when the PG motor E0003 is rotating in the reverse direction, the one-way clutch M5041 disengages blocking the driving force from being transmitted, so that the cap M5001 and the wiper blades M5011, M5012-1, M5012-2 are not operated.

The cap M5001 is made of an elastic member such as rubber and mounted on a cap lever M5004 that can be pivoted about its axis. The cap M5001 is moved in the direction of arrow A (FIG. 12) through the one-way clutch M5041, a cap drive transmission gear train M5110, a cap cam and the cap lever M5004 so that it can be brought into and out of contact with the print element substrate H1100 of the print head H1001. In the cap M5001 there is provided an absorbing member M5002 which is arranged to oppose the print element substrate H1100 with a predetermined gap therebetween during a capping operation.

The absorbing member M5002 disposed in this way can accept ink drawn out from the print head cartridge H1000 during the suction operation. Further, the ink in the cap M5001 can be discharged out into a used ink absorbing member completely by an evacuation operation described later. The cap M5001 is connected with two tubes, a cap tube M5009 and a valve tube M5010. The cap tube M5009 is connected to a pump tube M5019 of a pump M5100 described later and the valve tube M5010 to a valve rubber M5036 described later.

The wiper blades M5011, M5012-1, M5012-2 are made of elastic members such as rubber and are erected on a blade holder M5013 so that their edges project upward. The blade holder M5013 has a lead screw M5031 inserted therethrough with a projection not shown of the blade holder M5013 movably engaging in a groove formed in the lead screw M5031. As the lead screw M5031 rotates, the blade holder M5013 moves back and forth along the lead screw M5031 in the direction of arrow B1 or B2 (FIG. 12), causing the wiper blades M5011, M5012-1, M5012-2 to wipe clean the print element substrate H1100 of the print head cartridge H1000. The lead screw M5031 is connected to one side of the PG motor E0003 through the one-way clutch M5041 and a wiper drive transmission gear train M5120.

Designated M5100 is a pump that produces a pressure by pressing a roller (not shown) against and moving it along the pump tube M5019. This pump is connected to the other side of the PG motor E0003 via a drive path switching means and the pump drive transmission gear train M5130. The drive path switching means switches the driving force transmission path between the automatic sheet feed unit M3022 and the pump M5100. Although details are not provided, the pump M5100 has a mechanism to release the pressing force with which the roller (not shown) is pressed against the pump tube M5019 to squeeze it. When the PG motor E0003 rotates in the forward direction, the mechanism releases the pressing force from the roller, leaving the tube intact. When the PG motor E0003 rotates in the reverse direction, the mechanism applies the pressing force to the roller to squeeze the tube. One end of the pump tube M5019 is connected to the cap M5001 through the cap tube M5009.

The drive path switching means has a pendulum arm M5026 and a selector lever M5043. The pendulum arm M5026 is pivotable about a shaft M5026a in the direction of arrow C1 or C2 (FIG. 11) depending on the rotation direction of the PG motor E0003. The selector lever M5043 is switched according to the position of the carriage M4001. That is, when the carriage moves M4001 to a position over the ejection performance recovery unit M5000, a part of the selector lever M5043 is contacted by a part of the carriage M4001 and moved in the direction of arrow Dl or D2 (FIG. 11) depending on the position of the carriage M4001, with the result that a lock hole M5026b of the pendulum arm M5026 and a lock pin M5043a of the selector lever M5043 engage.

The valve rubber M5036 is connected with one end of the valve tube M5010 the other end of which is connected to the cap M5001. A valve lever M5038 is connected to the discharge roller 2003 (FIG. 5) through a valve cam M5035, a valve clutch M5048 and a valve drive transmission gear train M5140. As the discharge roller 2003 rotates, the valve lever M5038 is pivoted about a shaft M5038a in the direction of arrow E1 or E2 to come into or out of contact with the valve rubber M5036. When the valve lever M5038 is in contact with the valve rubber M5036, the valve is closed. When the lever is parted, the valve is open.

Denoted E0010 is a PG sensor that detects the position of the cap M5001.

Next, the operations of the ejection performance recovery unit M5000 of the above construction will be explained.

First, let us explain about the driving operation of the automatic sheet feed unit M3022.

When, with the carriage M4001 at the retracted position where it does not contact the selector lever M5043, the PG motor E0003 rotates in the reverse direction, the pendulum arm M5026 is pivoted in the direction of arrow C1 (FIG. 11) through a pendulum drive transmission gear train M5150, causing a selector output gear M5027 mounted on the pendulum arm M5026 to mesh with an ASF gear M5064 at one end of an ASF drive transmission gear train M5160. When in this state the PG motor E0003 continues to rotate in the reverse direction, the automatic sheet feed unit M3022 is driven by the PG motor through the ASF drive transmission gear train M5160. At this time, the driving force is not transmitted to the cap M5001 and the wiper blades M5011, M5012-1, M5012-2 because the one-way clutch M5041 is disengaged. Thus, the wiper blades are not operated.

I.9 Operation of Printer

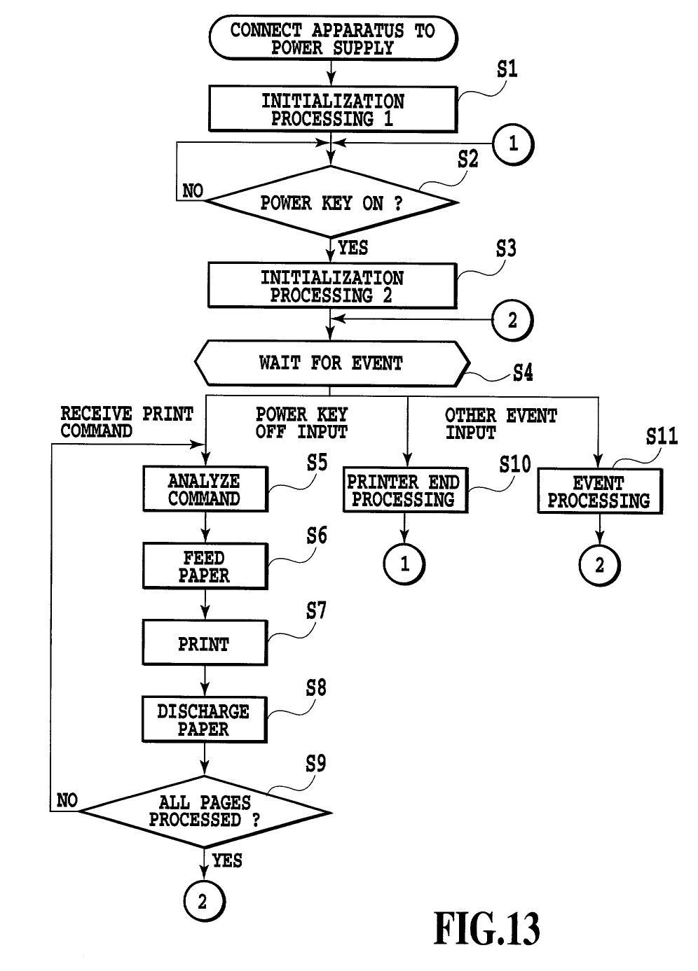

Next, the operation of the ink jet printing apparatus in this embodiment of the invention with the above configuration will be explained by referring to the flow chart of FIG. 13.

When the printer body M1000 is connected to an AC power supply, a first initialization is performed at step S1. In this initialization process, the electric circuit system including the ROM and RAM in the apparatus is checked to confirm that the apparatus is electrically operable.

Next, step S2 checks if the power key on the upper case M1002 of the printer body M1000 is turned on. When it is decided that the power key is pressed, the processing moves to the next step S3 where a second initialization is performed.

In this second initialization, a check is made of various drive mechanisms and the print head of this apparatus. That is, when various motors are initialized and head information is read, it is checked whether the apparatus is normally operable.

Next, steps S4 waits for an event. That is, this step monitors a demand event from the external I/F, a panel key event from the user operation and an internal control event and, when any of these events occurs, executes the corresponding processing.

When, for example, step S4 receives a print command event from the external I/F, the processing moves to step S5. When a power key event from the user operation occurs at step S4, the processing moves to step S10. If another event occurs, the processing moves to step S11.

Step S5 analyzes the print command from the external I/F, checks a specified paper kind, paper size, print quality, paper feeding method and others, and stores data representing the check result into the DRAM of the apparatus before proceeding to step S6.

Next, step S6 starts feeding the paper according to the paper feeding method specified by the step S5 until the paper is situated at the print start position. The processing moves to step S7.

At step S7 the printing operation is performed. In this printing operation, the print data sent from the external I/F is stored temporarily in the print buffer. Then, the CR motor is started to move the carriage M4001 in the main-scanning direction. At the same time, the print data stored in the print buffer is transferred to the print head H1001 to print one line. When one line of the print data has been printed, the LF motor E0002 is driven to rotate the LF roller M3001 to transport the paper in the sub-scanning direction. After this, the above operation is executed repetitively until one page of the print data from the external I/F is completely printed, at which time the processing moves to step S8.

At step S8, the LF motor E0002 is driven to rotate the paper discharge roller M2003 to feed the paper until it is decided that the paper is completely fed out of the apparatus, at which time the paper is completely discharged onto the paper discharge tray M1004.

Next at step S9, it is checked whether all the pages that need to be printed have been printed and if there are pages that remain to be printed, the processing returns to step S5 and the steps S5 to S9 are repeated. When all the pages that need to be printed have been printed, the print operation is ended and the processing moves to step S4 waiting for the next event.

Step S10 performs the printing termination processing to stop the operation of the apparatus. That is, to turn off various motors and print head, this step renders the apparatus ready to be cut off from power supply and then turns off power, before moving to step S4 waiting for the next event.

Step S11 performs other event processing. For example, this step performs processing corresponding to the ejection performance recovery command from various panel keys or external I/F and the ejection performance recovery event that occurs internally. After the recovery processing is finished, the printer operation moves to step S4 waiting for the next event.

I.10. Features of the Present Invention

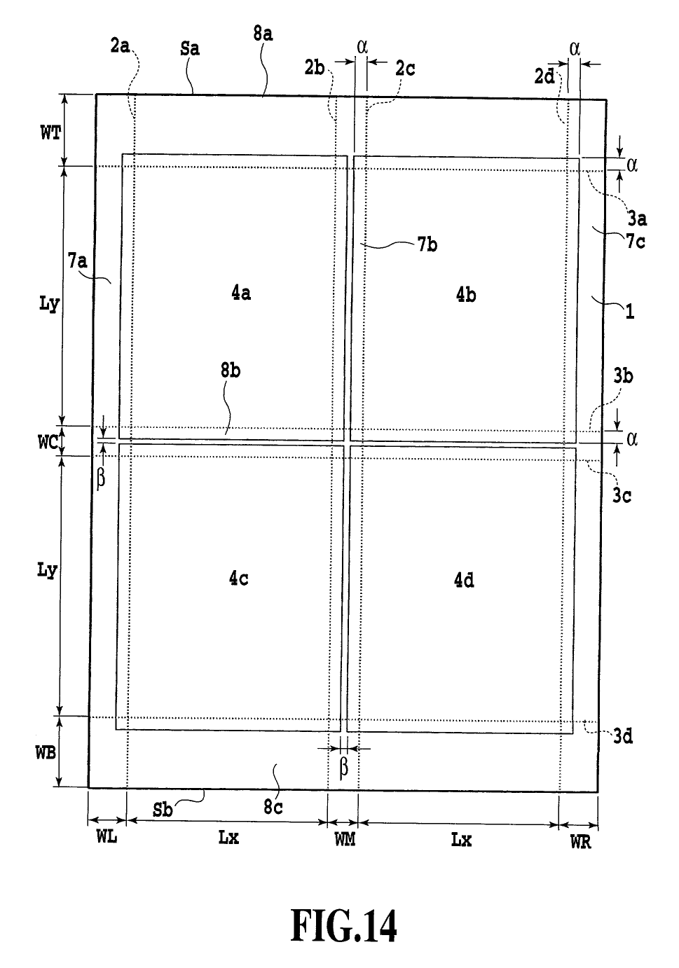

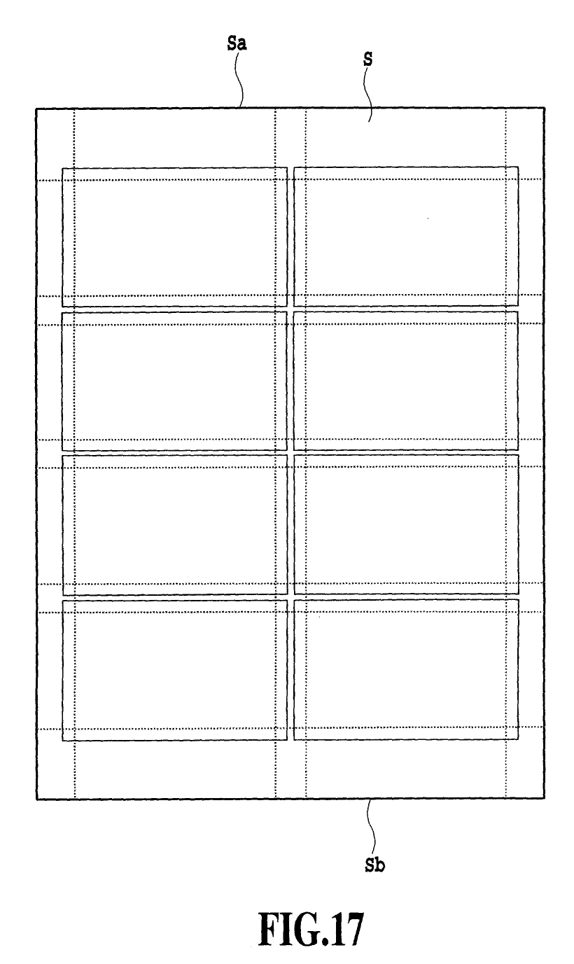

Embodiments of the present invention having the basic construction described above will be explained in terms of technological features of the invention by referring to FIGS. 14 to 17.

FIG. 14 is a schematic plan view showing a perforated print medium according to one embodiment of the invention.

In FIG. 14, the print medium 1 is formed with four vertical lines of perforations (2a, 2b, 2c, 2d) and four horizontal lines of perforations (3a, 3b, 3c, 3d). These vertical and horizontal lines of perforations define four independent print areas each measuring Ly long by Lx wide (4a, 4b, 4c, 4d).

Hence, in this embodiment, too, there is always a discard area around each image and the print medium has three vertical discard areas 7a, 7b, 7c and three horizontal discard areas 8a, 8b, 8c. A distance from the front end of the print medium 1 to the first horizontal perforation line 3a (width of the discard area 8a) is taken to be WT, a distance between the second and third horizontal perforation lines 3b and 3c situated between the print areas 4a, 4b and the print areas 4c, 4d (width of the discard area 8b) is taken to be WC, and a distance from the rear end of the print medium 1 to the fourth horizontal perforation line 3d (width of the discard area 8c) is taken to be WB. A distance from the left end of the print medium 1 to the first vertical perforation line 2a (width of the discard area 7a) is taken to be WL, a distance between the second and third vertical perforation lines 2b, 2c (with of the discard area 7b) is taken to be WM, and a distance from the right end of the print medium 1 to the fourth vertical perforation line 2d (width of the discard area 7c) is taken to be WR.

Further, the images to be printed in the print areas 4a-4d are each printed up to a mm beyond the perforation lines.

In this invention, the following settings are made: WT=WB=32 mm, WC=8 mm, WL=WR=12 mm, WM=8 mm and α=3 mm. These values are related to the construction of the printing apparatus that prints on the aforementioned print medium and will be explained in the following.

FIG. 15 is a partly cutaway, schematic vertical side view showing a transport passage for a print medium in the ink jet printing apparatus.

The print medium transport system in the ink jet printing apparatus basically has a print medium separation/feeding means 10 for storing a plurality of print mediums and for separating and feeding one sheet at a time, a transport means 20 for pressing a pinch roller 22 against a transport roller 21 to transport the print medium S by gripping it between the rollers 21, 22, and a discharge means 30 for pressing a spur roller 32 against a discharge roller 31 to grip the printed medium S between the rollers 31, 32 and discharge it out of the apparatus.

When the print medium S is placed in a paper feed tray 13 of the print medium separation/feeding means 10, a feed roller 11 is positioned a distance X from the front end Sa, with respect to the feeding direction (sub-scan direction) SD, of the print medium S to face the print medium S. When the feeding operation is started, the feed roller 11 is rotated and at the same time an urging member, such as a pressure plate, mounted on the paper feed tray 13 presses the print medium S against the feed roller 11. The print medium S is then fed in the feeding direction SD by the frictional force from the feed roller 11.

Further, a separation means is provided for separating a plurality of print mediums S one sheet at a time. This separation means normally employs a claw or frictional member for separation action. In the figure, designated 13a is a claw used as the separation means.

In the printing apparatus of this construction, the distance X from the front end, with respect to the feeding direction, of the print medium S to the feed roller 11 is normally set to about 3-30 mm. In this embodiment, the distance from the front end Sa of the print medium S to the first horizontal perforation line 3a is set to 32 mm, as described earlier, which is larger than the distance X. The reason for this setting is given below.

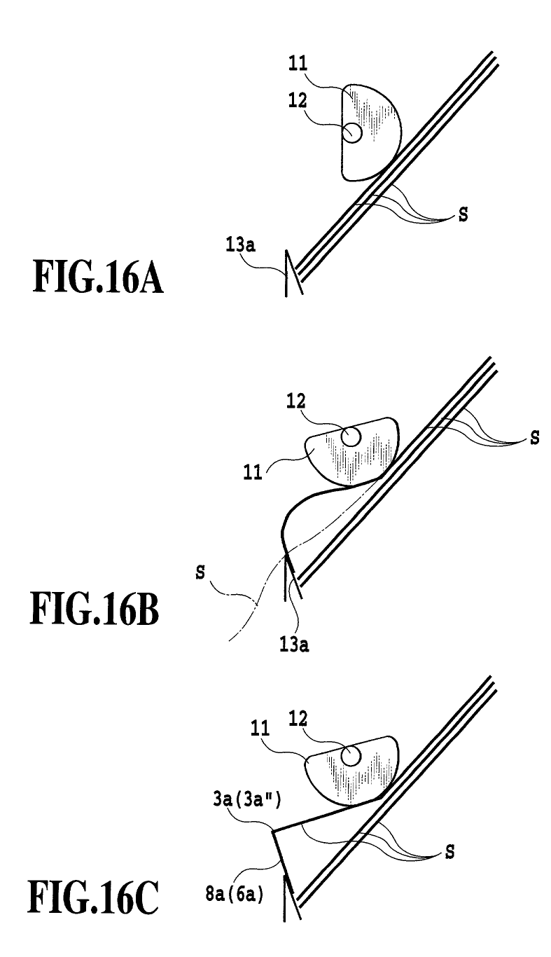

FIG. 16A, 16B, 16C shows the action of the separation/feeding means, in which the separation means uses a claw 13a for separating sheets.

FIG. 16A shows a plurality of stacked print mediums, with the front ends Sa, with respect to the feeding direction, of the print mediums engaging the claw of the separation means. In this state, when the feed roller 11 is rotated, the print medium S, because it is restricted at the front end by the claw 13a, gets deflected as shown in FIG. 16B. When the feed roller 11 is rotated further, the front end Sa of the print medium S rides over the claw 13a and is fed onto a guide g of the printing apparatus, from which it is fed to the transport roller 21. When the print medium is supplied onto the guide g, it is detected by a PE sensor 25. According to a detection signal, a control means such as CPU drives the transport means 20 and the discharge means 30.

If the distance from the front end Sa of the print medium S to the first horizontal perforation line 3a is set smaller than the distance X, when the print medium S fed by the feed roller 11 deflects as shown in FIG. 16B, the print medium S may bend along the perforation line formed in the deflected portion as shown in FIG. 16c and fail to be fed normally.

On the other hand, in this embodiment the distance from the front end of the print medium S to the first horizontal perforation line 3a is set larger than the distance X so that the perforation line is positioned upstream of the feed roller 11 (in the figure, behind the feed roller 11). Hence, when the print medium S is deflected, it does not bend along the perforation line and can reliably be separated and fed to the front side (downstream) of the claw 13a, as indicated by a one-dot chain line of FIG. 16B.

In this embodiment, because the distance from the feed roller 11 to the claw 13a in the print medium separation/feeding means 10, X, is set to 5-30 mm, the distance from the front end Sa of the print medium S to the first horizontal perforation line 3a is correspondingly set to 32 mm. The distance to the perforation line is not limited to this value. That is, because the distance X varies depending on the separation/feeding means 10 used, the distance from the front end Sa of the print medium S to the first horizontal perforation line needs only to be set larger than the distance X in the printing apparatus used to prevent the print medium S from being bent.

Next, the positional relation among the transport means 20, the printing means 40, the discharge means 30 and the print medium S will be explained.

In FIG. 15, the print head 40 as the printing means is arranged between two roller pairs—a pair of the transport roller 21 and the pinch roller 22 and a pair of the discharge roller 31 and the spur roller 32. The print head 40 has a plurality of nozzles 41 arranged in a predetermined range (a predetermined length in the print medium feeding direction). Of these nozzles 41, 41a denotes a nozzle situated on the most upstream side (a most upstream printing means) and 41b denotes a nozzle situated on the most downstream side (a most downstream printing means). In the figure, R designates a passage facing the print head 40 which extends from the transport means 20 to the discharge means 30.

In the above construction, the print medium S fed from the separation/feeding means 10 is further fed to the passage R by the transport roller pair of the transport roller 21 and the pinch roller 22. When the front end of the print medium S reaches the discharge roller pair of the discharge roller 31 and the spur roller 32, the print medium S is transported by both the transport roller pair and the discharge roller pair. Then, when the rear end of the print medium S leaves the transport roller pair, the print medium S is transported by only the discharge roller pair.

During the transport process described above, when the print medium S is fed by both the transport roller pair and the discharge roller pair, the print medium S is supported almost parallel to the print head and thus can be printed accurately.

When the print medium S is transported by only the transport roller pair or the discharge roller pair, it is supported by only one roller pair. In this case, the print medium S tilts and is not parallel to the print head 40, so that accurate printing often cannot be made. It follows therefore that the printing should be performed only when the print medium S is carried by both the transport roller pair and the discharge roller pair. This, however, reduces the print area on the print medium S. Hence, it is common practice to perform the printing operation also when the medium is transported only by the transport roller pair or discharge roller pair.

A range in which the print medium S is carried by only the transport roller pair while being printed corresponds to a period during which the front end Sa of the print medium S moves through a region Yt from the downstream nozzle 41b to the discharge roller pair shown in FIG. 15. A range in which the print medium S is carried by only the discharge roller pair while being printed corresponds to a period during which the rear end Sb of the print medium S moves through a region Yb from transport roller pair to the upstream nozzle 41a.

In the ordinary printing apparatus, Yt and Yb are in the range of 5-30 mm and the values of Yt and Yb may differ. In this embodiment, because the perforation lines that form the discard area WT in the front end part and the discard area WB in the rear end part are formed at positions 32 mm (WT=WB) inside the front end and the rear end of the print medium, as shown in FIG. 14, all the print areas 4a-4d inside these perforation lines can be printed while the print medium S is carried by both roller pairs—the transport roller pair and the discharge roller pair. Thus, when the print areas 4a-4d are being printed, the print medium S can be transported with high precision without any deviation, thus forming appropriate images.

As described above, the print medium S has two positional relationships with the printing apparatus, i.e., a relation (X) with respect to the structure of the separation/feeding means 10 and a relation (Yt, Yb) with respect to the positions of the transport roller pair, the discharge roller pair and the print head 40. The positions of the perforation lines are so determined as to meet these relationships. In this embodiment, because Yt=Yb=X, the two relations described above are satisfied by setting WB and WT to more than the same value (in this case, 32 mm). When the WT, WB and X have different values, however, the width WT of the discard area 8a in the front end portion needs to be set to more than X or Yt, whichever is greater, and the width WB of the discard area 8c in the rear end portion needs to be set to more than Yb.

Further, in this embodiment, the width of the vertical discard area 7b at the center, with respect to the horizontal direction, of the print area, WM, and the width of the horizontal discard area 8b at the center, with respect to the vertical direction, of the print area, WC, are both set to 8 mm and the width of the peripheral excess printed strip a outside each of the print areas 4a-4d is set to 3 mm. Hence, the width of an area that is not printed at all, β, is 2 mm. Providing the unprinted areas β in this way enables the print medium S to be transported properly. That is, when printed by the ink jet printing apparatus, the print medium S absorbs ink and thus its rigidity decreases. But by providing the unprinted blank areas as described above, the print medium as a whole can maintain an appropriate stiffness for precise transport even when the entire print areas are printed.

Further, the widths WT and WB of the discard areas 8a, 8c in the front and rear end portions are set larger than the width WC of the discard area Bb in the central portion with respect to the vertical direction, and the widths WL and WR of the discard areas 7a, 7c in the left and right end portions are set larger than the width WM of the discard area 7b in the central portion with respect to the horizontal direction. Of the discard areas of the print medium S, the peripheral discard areas 7a, 7c and 8a, 8c in particular are set larger in width to provide wide unprinted areas, thus preventing an overall stiffness of the print medium S from decreasing.

While in this embodiment the widths WM and WC of the discard areas 8b and 7b are set to 8 mm, because the stiffness of the print medium is greatly affected by the material and thickness of the print medium, it is preferred that the widths WC and WM of the discard areas be set larger when the print medium has small stiffness.

By optimizing the width of the excess printed strip spreading into the discard areas, as described above, it is possible to prevent an improper transport of print medium S due to a reduced stiffness of the medium and to improve the ease with which to handle the printed medium.

Further, by setting equal the widths WT, WB of the discard areas 8a, 8c in the front and rear end portions of the print medium S and setting equal the widths WL, WR of the discard areas 7a, 7c in the left and right end portions of the print medium S, the need is eliminated for checking the left and right sides of the print medium S when supplying the print mediums into the printing apparatus, facilitating the paper feeding operation.

In this embodiment the width of the excess printed strip α beyond the print areas is set to 3 mm. The reason for this setting is as follows.

When images are printed on a print medium, possible causes for deviations of the printed images from their predetermined positions include:

positional deviations that occur as the print medium is set in the separation/feeding means of the printing apparatus;

inclinations of the print medium that occur as the print medium is separated and fed from the separation/feeding means to the printing means; and

inclinations of the print medium that occur as the print medium is transported while being printed.

The print medium S itself has:

precision errors in cutting the print medium S into a predetermined size;

variations in size due to environment in which the print medium S is placed; and

variations in perforation line position produced as the print medium is perforated.

If these variations are assumed as follows:

inclinations of the print medium as it is sent to the printing means: ±1.0 mm,

precision of cutting the print medium S: ±0.5 mm,

size change of print medium S due to environment: ±0.5 mm, and

perforation precision: ±0.5 mm, then the total of these variations will be ±2.5 mm.

If the width of the excess printing strip is set to 3 mm, the image can be printed inside the perforation lines even under a worst case condition where the errors overlap most. These variations are influenced by the kind and size of the print medium S and change in various ways. Hence, by setting the width of the excess printing strip to an optimum value that matches the print medium used, it is possible to produce a print medium S with little waste.

In this embodiment, the explanation centered on a so-called four-image type print medium S which has four divided print areas. It should be appreciated that the present invention can similarly be implemented in print mediums S that are formed with two, six, eight or other number of images. A print medium with eight print areas are shown in FIG. 22 as another example.

While in this embodiment we have described the method of perforating the print medium as a means of separating the print areas from discard areas, the present invention can also be applied similarly, as with the above embodiment, to a print medium in which individual print areas in the form of sticking labels are positioned and pasted on a base sheet and peeled off after being printed. In that case, the base sheet may be of the same material as the print areas or, for reduced cost, may use different materials.

The forming of the perforations and the processing of the labels in the embodiment described above can be done using generally known processing methods. Further, while in the above descriptions the layout process for the print medium is not detailed, an appropriate image layout may be automatically or manually selected according to the kind of the print medium before performing the printing operation. This process can easily be performed by using a common photograph layout application program. Further, a printer driver for the ink jet printing apparatus may be used for positioning the images. The present invention therefore is not limited in the editing method, in particular.

Further, although in the embodiment above we have explained about the dimensional setting on various parts of the print medium when it is applied to the ordinary printing apparatus, an appropriate transport of the print medium can also be achieved as with the embodiment above by making a dimensional setting on the printing apparatus with respect to the print medium applied so that the print medium and the printing apparatus can satisfy the relation described in the embodiment above. That is, according to the widths WT, WB of the discard areas 8a, 8c of the print medium applied (see FIG. 14) the printing apparatus may be configured to have a dimensional setting of X, Yt, Yb (see FIG. 15) that satisfies a relationship similar to that of the embodiment above, i.e., the dimensional setting in which X and Yt are set smaller than the discard area WT and Yb is set smaller than the discard area WB. With this setting, the feeding and transport of the print medium S can be made properly.

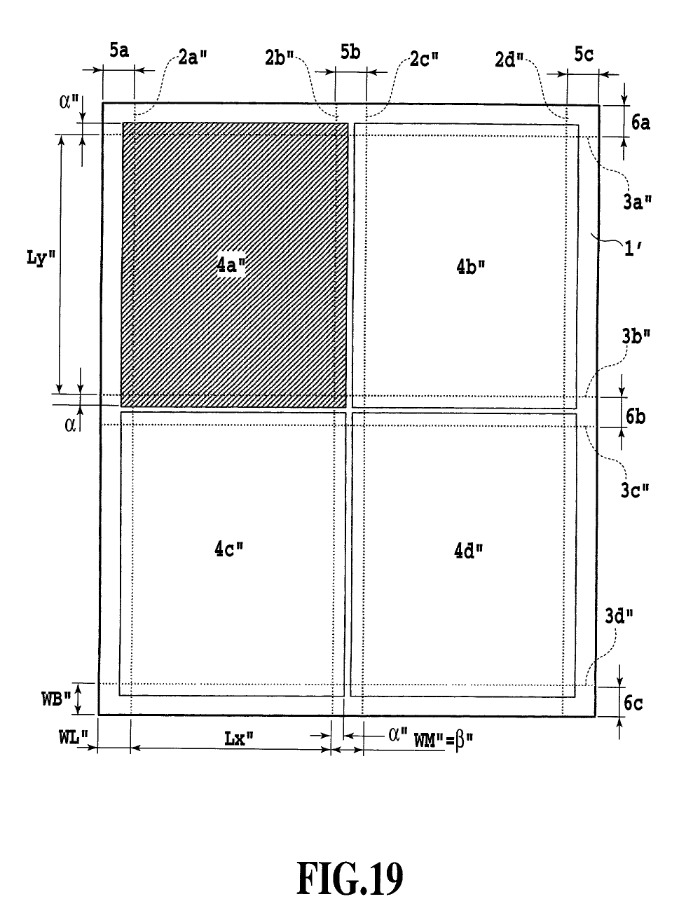

In the printing apparatus with X, Yt and Yb set according to the print medium S, when the dimensions described above are fixed, some limitations are imposed on the applicable print medium S. However, making the positions of the print medium separation/feeding means 10, the transport means 20 and the discharge means 30 changeable as required makes it possible to use a variety of print mediums, including a print medium of FIG. 19 with separable print areas but no discard areas, and to realize a general-purpose printing apparatus.

The present invention can also be applied similarly advantageously to print mediums with a single separable print area, in addition to those with two or more separable print areas.

One form of an effective application of this invention is the one in which thermal energy generated by electrothermal transducers is utilized to cause a film boiling in a liquid to form bubbles.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. A print medium to be supplied to a printing apparatus, wherein the printing apparatus has a feeding means for feeding the print medium accommodated in a predetermined accommodating portion to a transporting passage facing a predetermined printing means and transports the print medium fed by the feeding means along the transporting passage so that the printing means can print on the print medium, the print medium comprising:
a print area on which to print a desired image; and
a discard area provided separably in at least a front end portion of the print medium;
wherein a width of the discard area provided in at least a front end portion is set larger than a distance from a front end of the accommodating portion to the feeding means.

2. A print medium to be applied to a printing apparatus, wherein the printing apparatus has a transport means for transporting the print medium along a transporting passage facing a printing means and a discharge means arranged downstream of the transport means, and at least one of the transport means and the discharge means transports the print medium along the transporting passage so that the printing means can print on the print medium, the print medium comprising:
a print area on which to print a desired image; and
a discard area provided separably in at least a front end portion of the print medium;
wherein a width of the discard area provided in at least of the front end portion is set larger than a distance from a most downstream position printed by the printing means to the discharge means.

3. A print medium to be applied to a printing apparatus, wherein the printing apparatus has a transport means for transporting the print medium along a transporting passage facing a printing means and a discharge means arranged downstream of the transport means, and at least one of the transport means and the discharge means transports the print medium along the transporting passage so that the printing means can print on the print medium, the print medium comprising:
a print area on which to print a desired image; and
a discard area provided separably in at least a rear end portion of the print medium;
wherein a width of the discard area provided in at least of the rear end portion of the print media is set larger than a distance from a most upstream position printed by the printing means to the transport means.

4. A print medium to be applied to a printing apparatus, wherein the printing apparatus has a feeding means for feeding the print medium accommodated in a predetermined accommodating portion to a transporting passage facing a predetermined printing means, a transport means for transporting the print medium along a transporting passage and a discharge means arranged downstream of the transport means, and wherein after the print medium has been fed to the transporting passage, at least one of the transport means and the discharge means transports the print medium along the transporting passage so that the printing means can print on the print medium, the print medium comprising:
a print area on which to print a desired image; and
a discard area separably provided in at least a front end portion and a rear end portion of the print medium;
wherein a width of the discard area provided in the front end portion of the print medium is set larger than a distance from a front end of the accommodating portion to the feeding means or a distance from a most downstream position printed by the printing means to the discharge means, whichever is a greater distance;
wherein a width of the discard area provided in the rear end portion of the print medium is set larger than a distance from a most upstream position printed by the printing means to the transport means.

5. A print medium according to claim 1, wherein the print medium has a plurality of print areas and the widths of the discard areas in the front and rear end portions of the print medium are set larger than that of a discard area between the print areas.

6. A print medium according to claim 1, wherein widths of discard areas in left and right end portions of the print medium are set larger than a length in the transport direction of the discard area between the print areas.

7. A print medium according to claim 1, wherein the print medium has a plurality of print areas and separable discard areas before and after each print area, a discard area in a front end portion of the print medium and a discard area in a rear end portion of the print medium are set equal in width, and a discard area in a left end portion of the print medium and a discard area in a right end portion of the print medium are set equal in width.

8. A printing apparatus comprising:
an accommodating portion for accommodating a print medium, the print medium having a print area on which to print an image and a separable discard area in at least one of a front end portion and a rear end portion hereof; and
a feeding means for feeding the print medium accommodated in the accommodating portion to a transporting passage facing a predetermined printing means;
wherein the print medium fed by the feeding means is transported along the transporting passage so that the printing means can print on the print medium;
wherein the accommodating portion has a dimensional setting such that a distance from a front end of the accommodating portion to the feeding means is set smaller than a width of the discard area in the front end portion of the print medium.

9. A printing apparatus comprising:
a transport means for transporting a print medium along a transporting passage facing a printing means, the print medium having a print area on which to print an image and a discard area separably provided in at least one of a front end portion and a rear end portion thereof; and
a discharge means arranged downstream of the transport means;
wherein at least one of the transport means and the discharge means transports the print medium along the transporting passage so that the printing means can print on the print medium;
wherein a distance from a most downstream position printed by the printing means to the discharge means is set smaller than a width of the discard area provided in the front end portion of the print medium.

10. A printing apparatus comprising:
a transport means for transporting a print medium along a transporting passage facing a printing means, the print medium having a print area on which to print an image and a discard area separably provided in at least one of a front end portion and a rear end portion thereof; and
a discharge means arranged downstream of the transport means;
wherein at least one of the transport means and the discharge means transports the print medium along the transporting passage so that the printing means can print on the print medium;
wherein a distance from a most upstream position printed by the printing means to the transport means is set smaller than a width of the discard area provided in the rear end portion of the print medium.

11. A printing apparatus comprising:
a feeding means for feeding a print medium to a transporting passage facing a predetermined printing means, the print medium having a print area on which to print an image and a discard area separably provided in at least one of a front end portion and a rear end portion thereof;
a transport means for transporting the print medium along the transporting passage; and
a discharge means arranged downstream of the transport means;
wherein after the print medium accommodated in a predetermined accommodating portion has been fed to the transporting passage, at least one of the transport means and the discharge means transports the print medium along the transporting passage so that the printing means can print on the print medium;
wherein the print medium has a print area on which to print a desired image and a discard area separably provided in at least a front end portion and a rear end portion thereof;
wherein a distance from a most downstream position printed by the printing means to the discharge means or a distance from a most upstream position printed by the printing means to the transport means, whichever is a greater distance, is set smaller than a width of the discard area provided in the front end portion of the print medium, and a distance from a most upstream position printed by the printing means to the transport means is set smaller than a width of the discard area provided in the rear end portion of the print medium.
